(19) United States
(12) Patent Application Publication
(10) Pub. No.: US 2008/0030063 A1
(43) Pub. Date: Feb. 7, 2008

(54) Seat belt position adjuster and seat belt device including the same

(75) Inventors: Yuki Tabata, Tokyo (JP); Yukio Nagayoshi, Tokyo (JP); Masahiko Iwai, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: TAKATA CORPORATION, Tokyo (JP)

(21) Appl. No.: 11/802,968

(22) Filed: May 29, 2007

(30) Foreign Application Priority Data
Jun. 7, 2006 (JP) 2006-158577

(51) Int. Cl. B60R 22/00

(52) U.S. Cl. 297/468; 297/474

(57) ABSTRACT

A seat belt position adjuster includes a guide rail attached to a vehicle body and a slider slidably provided to the guide rail. The slider swingably supports a belt anchor that guides a seat belt. The slider includes a boss portion that supports the belt anchor, and slides with respect to the guide rail to adjust the position of the seat belt. The boss portion includes an inner diameter that is kept constant between a base portion and a leading end portion of the boss portion, and an outer diameter that is continuously reduced from the base portion toward a leading end of the boss portion.

### BACKGROUND OF THE INVENTION AND RELATED ART STATEMENT

The present invention relates to a seat belt position adjuster for use in a seat belt device used in a vehicle to adjust the position of a seat belt, and to a seat belt device including the adjuster.

A seat belt device mounted on a vehicle, such as an automobile, for example, is for restraining and protecting an occupant from being inertially moved when the vehicle is applied with a large deceleration in the event of a vehicle collision, or the like. Conventionally, as one of such seat belt devices, there is a three-point seat belt device, as illustrated in FIG. 3, for example.

In the figure, the reference numeral 1 indicates a seat belt device attached to a vehicle seat 2, and the reference numeral 3 indicates a seat belt retractor fixed to a vehicle body in the vicinity of the vehicle seat 2 to keep a seat belt 4 withdrawably retracted in a normal state and to prevent the seat belt 4 from being withdrawn in the event of an emergency. The reference numeral 5 indicates a tongue slidably supported by the seat belt 4, and the reference numeral 6 indicates a buckle fixed to the vehicle seat 2 or the vehicle body to be latched with the tongue 5. The reference numeral 7 indicates a belt anchor (alternatively referred to as a shoulder anchor) attached to an upper position of a side portion of the vehicle body such as a center pillar 8, to guide the seat belt 4 withdrawn from the seat belt retractor 3. The reference numeral 9 indicates a seat belt position adjuster for adjusting the height position of the belt anchor 7. A leading end portion 4a of the seat belt 4 withdrawn from the seat belt retractor 3 is fixed to the vehicle seat 2 or the vehicle body. Further, FIG. 3 illustrates a state in which the seat belt 4 is withdrawn from the seat belt retractor 3 by a predetermined length, although the tongue 5 is not latched in the buckle 6.

According to the thus configured seat belt device 1, when the occupant wears the seat belt 4, the occupant sits on the vehicle seat 2, withdraws the seat belt 4 from the seat belt retractor 3, latches the tongue 5 in the buckle 6, and thereafter releases his hands from the tongue 5. Thus, the seat belt 4 is applied to the occupant with an unnecessarily withdrawn portion of the seat belt 4 retracted by the seat belt retractor 3 to remove a slack of the seat belt 4.

It is desirable to apply the seat belt 4 to the occupant at a position fitted as properly as possible to the occupant to effectively restrain the occupant in the event of an emergency and allow the occupant to feel comfortable in the vehicle without having a feeling of pressure and the like when the occupant normally sitting in the vehicle, for example. In particular, a shoulder belt 4b for supporting an area from a shoulder across the chest to the abdomen of the occupant is required to be applied to the occupant at a further fitted position. The occupant may include a child and an adult, and the adult includes a large-built person and a small-built person, for example. Thus, the occupant has a different and varied physical size. In view of this, the seat belt device 1 conventionally includes the seat belt position adjuster 9, which makes the position of the seat belt 4 adjustable so that the seat belt 4 can be applied to each of occupants of different and varied physical sizes at a position fitted as comfortably as possible to the occupant.

Generally, the conventional seat belt position adjuster 9 of the above type includes at least a guide rail 10 provided at an upper position of the side portion of the vehicle body such as the center pillar 8, to extend in the height direction (the vertical direction), and a slider 11 slidably provided to the guide rail 10 to swingably support the belt anchor 7 which guides the seat belt 4 withdrawn from the seat belt retractor 3.

To adjust the height position of the belt anchor 7 to a desired height position, a not-illustrated operation button provided on slider 11 is operated to pull a latch pin (not illustrated) out of one of positioning holes (not illustrated) of the guide rail 10. Thereafter, the slider 11 is vertically moved toward the desired height position, and the latch pin is inserted in and engaged with the positioning hole of the guide rail 10 corresponding to or closest to the desired height position. Thereby, the height position of the belt anchor 7 is adjusted to the height position desired by the occupant, and the seat belt 4 is applied to the occupant at the fitted position.

Meanwhile, the slider 11 is formed with a boss portion to support the belt anchor 7. As illustrated in FIG. 4(a), as the boss portion, there has conventionally been a boss portion 12 having a boss member 12′, which includes an internal thread 12a and is formed separately from and fixed to the slider 11. However, the use of such a separately formed boss member 12′ causes a problem of an increase in the weight and also an increase in the number of components and thus an increase in the number of manufacturing processes.

In light of this, there has been proposed a slider 11 of the seat belt position adjuster 9 having a boss portion 12 which is integrally formed with the slider 11 by a burring process, as illustrated in FIG. 4(b), to thereby reduce the weight and to reduce the number of components and the number of manufacturing processes (see Patent Documents 1 and 2, for example).

[Patent Document 1] Japanese Examined Patent Application Publication No. 7-71920

[Patent Document 2] Japanese Unexamined Patent Application Publication No. 2004-106720

Conventionally, in the formation of the boss portion 12 by the burring process, the boss portion 12 is processed in many cases by employing a die including a processing hole having a constant inner diameter in the longitudinal direction thereof, and a punch having a constant outer diameter in the longitudinal direction thereof. During the burring process, a leading end portion 12b of the boss portion 12 is first stretched and pressed into the processing hole of the die. Thus, as illustrated in FIG. 4(c), the outer diameter of the boss portion 12 formed by the burring process is constant, with an outer diameter a of a base portion 12c of the boss portion 12 being equal to an outer diameter b of a leading end 12d (a=b). Further, the inner diameter of the boss portion 12 changes to continuously increase from the base portion 12c toward the leading end 12d, and a difference in inner diameter is caused, with an inner diameter d of the leading end 12d being greater than an inner diameter c of the base portion 12c (d>c). Due to the difference in the inner diameter, the base portion 12c of the boss portion 12 is formed to have a greater wall thickness than the wall thickness of the leading end portion 12b of the boss portion 12.

To firmly support the belt anchor 7, the length of the effective internal thread 12a needs to be increased in FIG. 4(b). In other words, a height (amount of protrusion) e of the boss portion 12 needs to be increased by a certain degree in FIG. 4(c). If the height e of the boss portion 12 is thus simply increased in the burring process, however, thread cutting with a tap cannot be effectively performed, since the inner diameter of the boss portion 12 continuously and significantly changes from the base portion 12c toward the leading end 12d, as described above. As a result, it becomes difficult to form the effective internal thread 12a. Thus, in the formation of the boss portion 12 by the burring process with the use of the die including a processing hole having a constant inner diameter and the punch having a constant outer diameter, the height e of the boss portion 12 cannot be increased much. Therefore, there is a problem in that the length of the effective internal thread 12a cannot be increased much. The same is true of thread cuttings other than the thread cutting with a tap.

### SUMMARY OF THE INVENTION

The present invention has been made in view of the above circumferences. An object of the present invention is to provide a seat belt position adjuster which, even if a boss portion of a slider for supporting a belt anchor is formed by a burring process, the height of the boss portion is greater than the height of a conventional boss portion preventing a difference in inner diameter of the boss portion, and to provide a seat belt device including the adjuster.

Further objects and advantages of the invention will be apparent from the following description of the invention.

To solve the above-described problems, a seat belt position adjuster, according to the invention of the first aspect, includes at least a guide rail attached to a vehicle body, and a slider slidably provided to the guide rail to swingably support a belt anchor, which guides a seat belt. The slider, including a boss portion formed by a burring process, supports the belt anchor and slides with respect to the guide rail to adjust the position of the seat belt. The seat belt position adjuster is characterized in that the boss portion is configured such that the inner diameter of the boss portion is kept constant between a base portion and a leading end portion of the boss portion, and that the outer diameter of the boss portion is continuously reduced from the base portion toward a leading end of the boss portion.

Further, a seat belt device, according to the invention of a second aspect, includes at least a seat belt retractor for keeping a seat belt withdrawably retracted in a normal state and preventing the seat belt from being withdrawn in the event of an emergency. In addition, the seat belt device includes a tongue slidably supported by the seat belt, a buckle fixed to a vehicle seat or a vehicle body to be latched with the tongue, a belt anchor attached to the vehicle body to guide the seat belt withdrawn from the seat belt retractor, and a seat belt position adjuster for adjusting the position of the belt anchor. The seat belt position adjuster is used to adjust the position of the belt anchor to thereby adjust the position of the seat belt with respect to an occupant. The seat belt device is characterized in that the seat belt position adjuster is the seat belt position adjuster described in the first aspect.

According to the thus configured seat belt position adjuster of the present invention, the boss portion formed by the burring process includes an inner diameter that is kept constant without having a difference in inner diameter. Thus, the height (the amount of protrusion) of the boss portion can be made greater than the height of a conventional boss portion. Accordingly, it is possible to effectively perform the thread cutting on the boss portion by using a tap, and to form an effective internal thread longer than a conventional internal thread. Due to the increase in length of the effective internal thread, therefore, the support of the belt anchor can be more firmly maintained.

Further, according to the seat belt device of the present invention, which includes the seat belt position adjuster of the present invention, the support of the belt anchor can be more firmly maintained. Accordingly, the occupant can be more effectively restrained and protected from being inertially moved when a vehicle is applied with a large deceleration in the event of a vehicle collision or the like.

### BRIEF DESCRIPTION OF THE DRAWINGS

FIGS. 1(a) and 1(b) illustrate a guide rail and a slider of an embodiment of a seat belt position adjuster according to the present invention, wherein FIG. 1(a) is a perspective view and FIG. 1(b) is a cross-sectional view taken along line 1(b)-1(b) of FIG. 1(a).

FIGS. 2(a) and 2(b) illustrate the slider of the embodiment illustrated in FIGS. 1(a) and 1(b), wherein FIG. 2(a) is a cross-sectional view of the slider in the longitudinal direction thereof and FIG. 2(b) is an explanatory diagram of a boss portion formed by a burring process.

FIG. 3 is a diagram illustrating a commonly-used conventional three-point seat belt device installed in an automobile.

FIGS. 4(a)-4(c) illustrate sliders used in a conventional seat belt position adjuster, wherein FIG. 4(a) is a cross-sectional view of a slider according to one embodiment, 4(b) is a cross-sectional view of a slider according to another embodiment, and 4(c) is an explanatory diagram of a boss portion of the slider illustrated in FIG. 4(b) formed by a burring process.

### DETAILED DESCRIPTION OF THE EMBODIMENTS

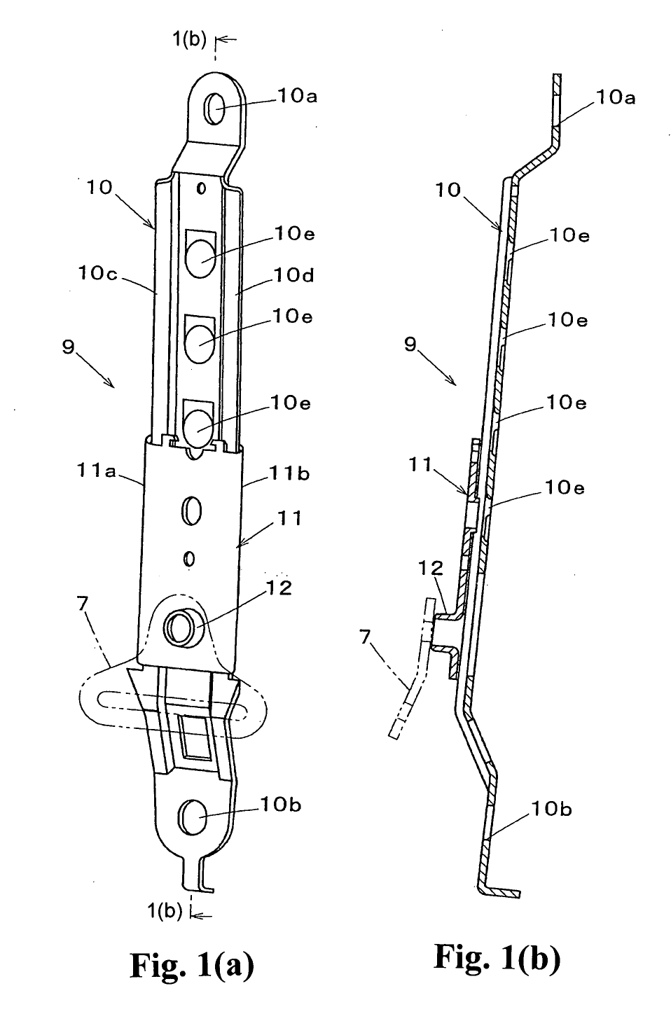

The best mode for carrying out the present invention will be described below with reference to the drawings. FIGS. 1(a) and 1(b) illustrate a guide rail and a slider of an embodiment of a seat belt position adjuster according to the present invention. FIG. 1(a) is a perspective view, and FIG. 1(b) is a cross-sectional view taken along line 1(b)-1(b) of FIG. 1(a). The same components as the components of the above-described conventional example are assigned with the same reference numerals, and detailed description thereof will be omitted.

As illustrated in FIGS. 1(a) and 1(b), the seat belt position adjuster 9 of the present embodiment also includes a guide rail 10 and a slider 11. The guide rail 10 extends in the vertical direction (the height direction), and is disposed at an upper position of the side portion of the vehicle body, such as the center pillar 8. The guide rail 10 is attached by passing not-illustrated bolts through attachment holes 10a and 10b formed in upper and lower ends of the guide rail 10 and screwing the bolts into the side portion of the vehicle body.

The left and right side edges of the guide rail 10 are provided with rail portions 10c and 10d, respectively, which extend in the vertical direction. Further, the center of the guide rail 10 is drilled with a predetermined number of positioning holes 10e at predetermined intervals in the vertical direction.

The slider 11 is provided to also extend in the vertical direction. The left and right side edges of the slider 11 are bent to form guided portions 11a and 11b. The guided portions 11a and 11b slidably engage with the rail portions 10c and 10d of the guide rail 10, respectively, to vertically move while being guided by the rail portions 10c and 10d.

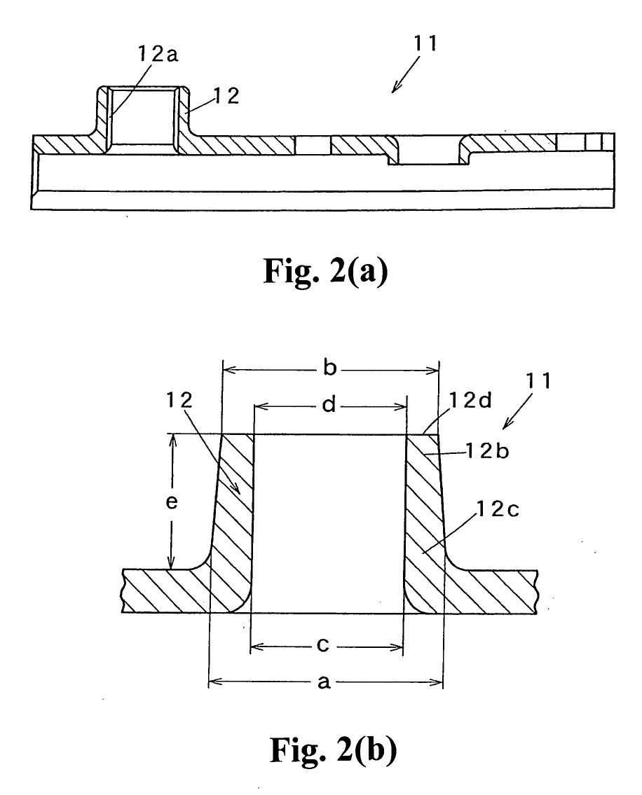

As illustrated in FIG. 1(a), similarly to the conventional slider 11, the slider 11 of the present embodiment is also provided with the boss portion 12, which protrudes from the slider 11 to swingably support the belt anchor 7. As illustrated in FIG. 2(a), the boss portion 12 is integrally formed with the slider 11 by the burring process, and the inner circumferential surface of the boss portion 12 is formed with the internal thread 12a. As illustrated in FIG. 2(b), the outer diameter b of the leading end 12d of the boss portion 12 is smaller than the outer diameter a of the base portion 12c of the boss portion 12 (b<a). Meanwhile, the inner diameter d of the leading end 12d of the boss portion 12 is equal to the inner diameter c of the base portion 12c of the boss portion 12 (c=d). That is, while the outer diameter of the boss portion 12 changes to be reduced from the base portion 12c toward the leading end 12d, the inner diameter of the boss portion 12 is kept constant without changing from the base portion 12c toward the leading end 12d. Thus, the boss portion 12 does not have a difference in inner diameter.

In the boss portion 12 of the present embodiment, the leading end portion 12b of the boss portion 12 is thinner than the base portion 12c due to the burring process. However, the inner diameters c and d of the boss portion 12 are constant and are equal to each other, as described above. Thus, as illustrated in FIG. 2(b), there arises a difference in outer diameter between the outer diameter b at the leading end 12d of the boss portion 12 and the outer diameter a at the base portion 12c, i.e., the outer diameter b of the leading end 12d is smaller than the outer diameter a of the base portion 12c (b<a).

According to the seat belt position adjuster 9 of the present embodiment, the boss portion 12 formed by the burring process is kept constant in inner diameter without having a difference in inner diameter. Therefore, a height (amount of protrusion) e of the boss portion 12 can be made greater than the height of the conventional boss portion. Accordingly, it is possible to effectively perform the thread cutting on the boss portion 12 by using a tap, and to form the effective internal thread 12a longer than a conventional internal thread. Due to the increase in length of the effective internal thread 12a, therefore, the support of the belt anchor 7 can be more firmly maintained.

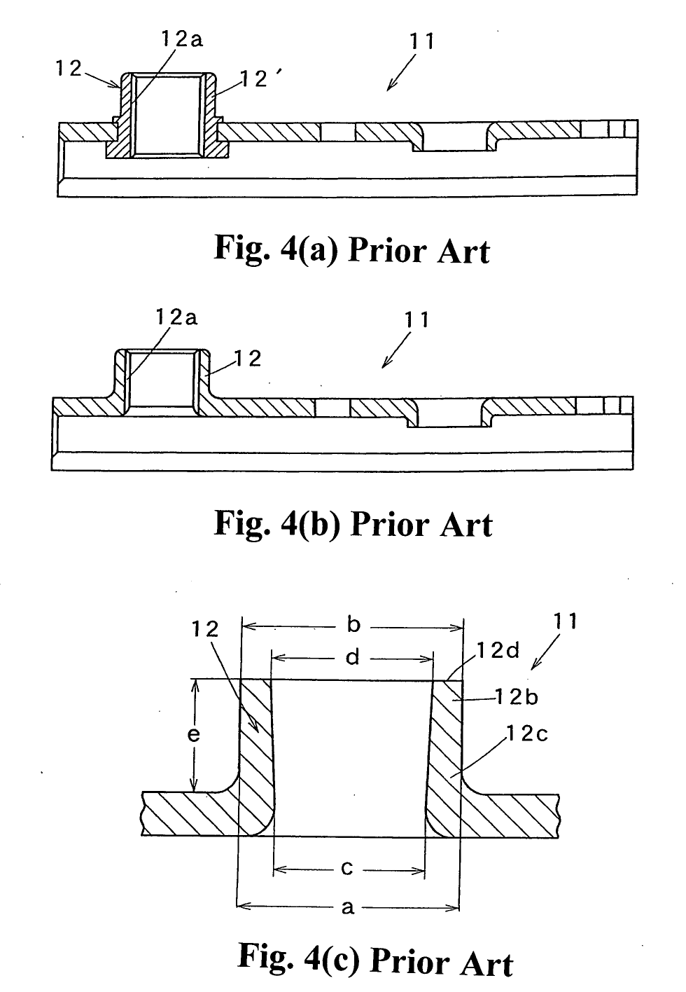

Other configurations and other operations and effects of the seat belt position adjuster 9 of the present embodiment are the same as the configurations and the operations and effects of the commonly-used conventional seat belt position adjuster provided with the slider 11 as illustrated in FIG. 4(b) including the boss portion 12 formed by the burring process.

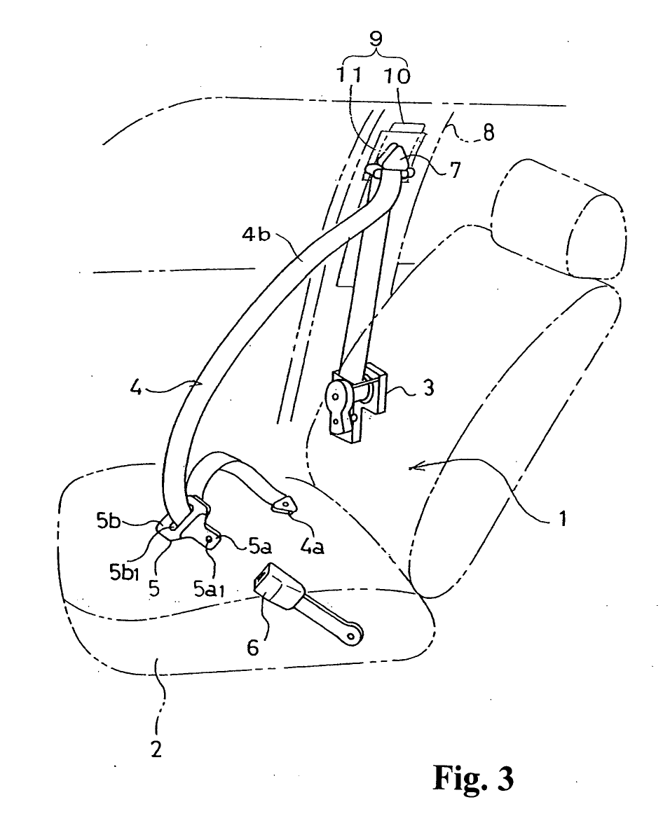

Further, the seat belt position adjuster 9 of the present embodiment can be applied to the seat belt position adjuster 9 of the commonly-used conventional three-point seat belt device 1 illustrated in FIG. 3, for example. Provided with the seat belt position adjuster 9 of the present embodiment, the seat-belt device 1 can more firmly maintain the support of the belt anchor 7 and more effectively restrain and protect an occupant from being inertially moved when a vehicle is applied with a large deceleration in the event of a vehicle collision or the like.

The seat belt position adjuster according to the present invention and the seat belt device including the adjuster can be preferably applied to a seat belt position adjuster for adjusting the height position of a seat belt of a seat belt device used in a vehicle, and to a seat belt device including the adjuster.

The disclosure of Japanese Patent Application No. 2006-158577 filed on Jun. 7, 2006 is incorporated as a reference.

While the invention has been explained with reference to the specific embodiments of the invention, the explanation is illustrative and the invention is limited only by the appended claims.

What is claimed is:

1. A seat belt position adjuster comprising:
a guide rail attached to a vehicle body; and
a slider slidably attached to the guide rail for swingably supporting a belt anchor that guides a seat belt, the slider including a boss portion for supporting the belt anchor and sliding with respect to the guide rail to adjust a position of the seat belt;
wherein the boss portion comprises an inner diameter that is kept constant between a base portion and a leading end portion of the boss portion, and an outer diameter that is continuously reduced from the base portion toward the leading end of the boss portion.

2. The seat belt position adjuster according to claim 1, wherein the boss portion is integrally formed with the slider by a burring process.

3. A seat belt device comprising at least:
a seat belt;
a seat belt retractor configured to keep the seat belt withdrawably retracted in a normal state and preventing the seat belt from being withdrawn in an emergency;
a belt anchor to be attached to a vehicle body to guide the seat belt withdrawn from the seat belt retractor; and
a seat belt position adjuster for adjusting a position of the belt anchor, the seat belt position adjuster operable to adjust the position of the belt anchor to thereby adjust the position of the seat belt with respect to an occupant;
wherein the seat belt position adjuster is the seat belt position adjuster according to claim 1.

4. The seat belt device according to claim 3, further comprising:
a tongue slidably supported by the seat belt; and
a buckle fixed to a vehicle seat or a vehicle body, the buckle configured to be latched with the tongue.
